(19) United States
(12) Patent Application Publication
(10) Pub. No.: US 2014/0156685 A1
(43) Pub. Date: Jun. 5, 2014

(54) Loopback structure and data loopback processing method of processor

(71) Applicants: Lihuang Li, Shenzhen (CN); Wei Li, Shenzhen (CN)

(72) Inventors: Lihuang Li, Shenzhen (CN); Wei Li, Shenzhen (CN)

(73) Assignee: ZTE CORPORATION, Shenzhen, Guangdong (CN)

(21) Appl. No.: 14/117,244

(22) PCT Filed: Sep. 15, 2011
(86) PCT No.: PCT/CN11/79663

§ 371 Date: Nov. 12, 2013

(30) Foreign Application Priority Data
May 12, 2011 (CN) 201110122402.5

(51) Int. Cl. G06F 17/30

(52) U.S. Cl. CPC G06F 17/30569
USPC 707/756

(57) ABSTRACT

The disclosure discloses a loopback structure and data loopback processing method of a processor. The loopback structure includes a register file unit, a data storing unit, and a data reading unit; wherein the register file unit is configured to provide a data reading-writing service for the data storing unit and the data reading unit; the data storing unit is connected to the register file unit, and is configured to read data via a reading port of the register file unit, to perform a data transformation on the read data, and to feed the transformed data back to the data reading unit; and the data reading unit is connected to the register file unit and the data storing unit, and is configured to transform the data fed back by the data storing unit, and to write the transformed data in the register file unit via a writing port of the register file unit. With the disclosure, it is possible to increase efficiency of the processor and decrease power consumption of the processor.

### TECHNICAL FIELD

The disclosure relates to the field of processor-architecture design, and in particular to a loopback structure and data loopback processing method of a processor.

### BACKGROUND

A processor is a core component in a chip, and efficiency and power consumption of the processor affect largely that of the whole chip. Therefore, what needs to be considered in processor-architecture design is how to increase the efficiency of the processor and decrease the power consumption of the processor.

As shown in FIG. 1, three data channels are provided in conventional processor-architecture, namely:

a 1st channel through “ memory→data reading unit→register file unit ”;

a 2nd channel through “register file unit→computing unit→register file unit ”, which is also called a front channel; and

a 3rd channel through “register file unit→data storing unit→memory ”.

In the conventional processor-architecture, before starting a computation, the data reading unit first reads an operand in the memory and sends the operand to the register file unit; then the computing unit reads the operand from the register file unit to start the computation, and writes a result of the computation back into the register file unit; finally, the data storing unit reads the result of the computation from the register file unit, and stores the result of the computation in the memory.

In the conventional processor-architecture, although data computation may be performed in cycles within the front channel consisting of “register file unit→computing unit→register file unit”, the computing unit however can perform only an arithmetic logic computation, but not a special data transformation provided by the data reading unit and the data storing unit (such as data rotation-displacement). Therefore, if a special data transformation provided by the data reading unit and the data storing unit is to be performed, the processor has to write data back into the memory, and then read the data from the memory once again. An operation directed to the memory will cost the power consumption and time of the processor, in which case frequent reading-writing of the memory by the processor will have a major impact on the efficiency and power consumption of the whole processor.

### SUMMARY

In view of this, a main purpose of the disclosure is to provide a loopback structure and data loopback processing method of a processor, so as to increase efficiency of the processor and decrease power consumption of the processor.

To achieve this purpose, a technical solution of the disclosure is implemented as follows.

The disclosure provides a loopback structure of a processor, which includes a register file unit, a data storing unit, and a data reading unit: wherein:

the register file unit is configured to provide a data reading-writing service for the data storing unit and the data reading unit;

the data storing unit is connected to the register file unit, and is configured to read data via a reading port of the register file unit, to perform a data transformation on the read data, and to feed the transformed data back to the data reading unit; and

the data reading unit is connected to the register file unit and the data storing unit, and is configured to transform the data fed back by the data storing unit, and to write the transformed data in the register file unit via a writing port of the register file unit.

A data computing and transforming unit may be connected between the data storing unit and the data reading unit, and

the data computing and transforming unit may be configured to perform computation and transformation processing on the data fed back by the data storing unit, and provide the processed data to the data reading unit.

The data storing unit may be configured to mask an operation directed to a memory of the processor by the data storing unit itself when the data storing unit processes the data read via the reading port.

The loopback structure may further include a computing unit connected to the register file unit and configured to read a source operand from the register file unit, to perform a data computation based on the source operand, and to write a result of the computation in the register file unit.

The data storing unit may be configured to read the result of the computation based on the source operand via the reading port of the register file unit, to perform the data transformation on the read result of the computation, and to feed the transformed result of the computation back to the data reading unit; and

accordingly, the data reading unit may be configured to transform the result of the computation fed back by the data storing unit, and to write the transformed result of the computation in the register file unit via the writing port of the register file unit.

The data transformation may be a data rotation-displacement operation.

The disclosure further provides a data loopback processing method of a processor, including:

reading, by a data storing unit, data via a reading port of a register file unit, performing a data transformation on the read data, and feeding the transformed data back to a data reading unit; and

transforming, by the data reading unit, the data fed back by the data storing unit, and writing the transformed data in the register file unit via a writing port of the register file unit.

The method may further include:

performing, by a data computing and transforming unit connected between the data storing unit and the data reading unit, performing computation and transformation processing on the data fed back by the data storing unit, and providing the processed data to the data reading unit.

The method may further include:

masking, by the data storing unit, an operation directed to a memory of the processor by the data storing unit itself when the data storing unit processes the data read via the reading port.

The method may further include:

reading, by a computing unit connected to the register file unit, a source operand from the register file unit, performing a data computation based on the source operand, and writing a result of the computation in the register file unit.

The method may further include:

reading, by the data storing unit, the result of the computation based on the source operand via the reading port of the register file unit, performing the data transformation on the read result of the computation, and feeding the transformed result of the computation back to the data reading unit; and

transforming, by the data reading unit, the result of the computation fed back by the data storing unit, and writing the transformed result of the computation in the register file unit via the writing port of the register file unit.

The data transformation may be a data rotation-displacement operation.

The loopback structure and data loopback processing method of a processor provided by the disclosure provides an instruction and a channel directly from the data storing unit to the data reading unit; by providing the instruction and channel, after the computation by the computing unit and the data transformation by the data storing unit, data are not written into the memory directly, but are looped and fed back to the data reading unit. The channel reuses a special data transformation function of the data storing unit and the data reading unit (including data rotation-displacement and the like) as well as their reading and writing ports of the register file unit, and another data computing and transforming unit may be added between the data storing unit and the data reading unit as needed; this channel and the channel of “register file unit→computing unit→register file unit ” are independent of each other, and may operate in parallel, that is, they may work independently without affecting each other.

With the disclosure, reading and writing operations to the memory by the processor, or any reading and writing conflicts due to such operations, is exempted, thereby increasing work efficiency of the processor and decreasing power consumption of the processor effectively.

### BRIEF DESCRIPTION OF THE DRAWINGS

FIG. 1 is a schematic diagram of processor-architecture in the related art;

FIG. 2 is a 1st schematic diagram of a loopback structure of a processor in an embodiment of the disclosure;

FIG. 3 is a 2nd schematic diagram of a loopback structure of a processor in an embodiment of the disclosure;

FIG. 4 is a sequence diagram of data loopback processing by a processor in an embodiment of the disclosure;

FIG. 5 is a schematic diagram of independent front and the back channels in a loopback structure of a processor according to an embodiment of the disclosure; and

FIG. 6 is a schematic diagram of a closed loop formed by a front channel and a back channel in a loopback structure of a processor according to an embodiment of the disclosure.

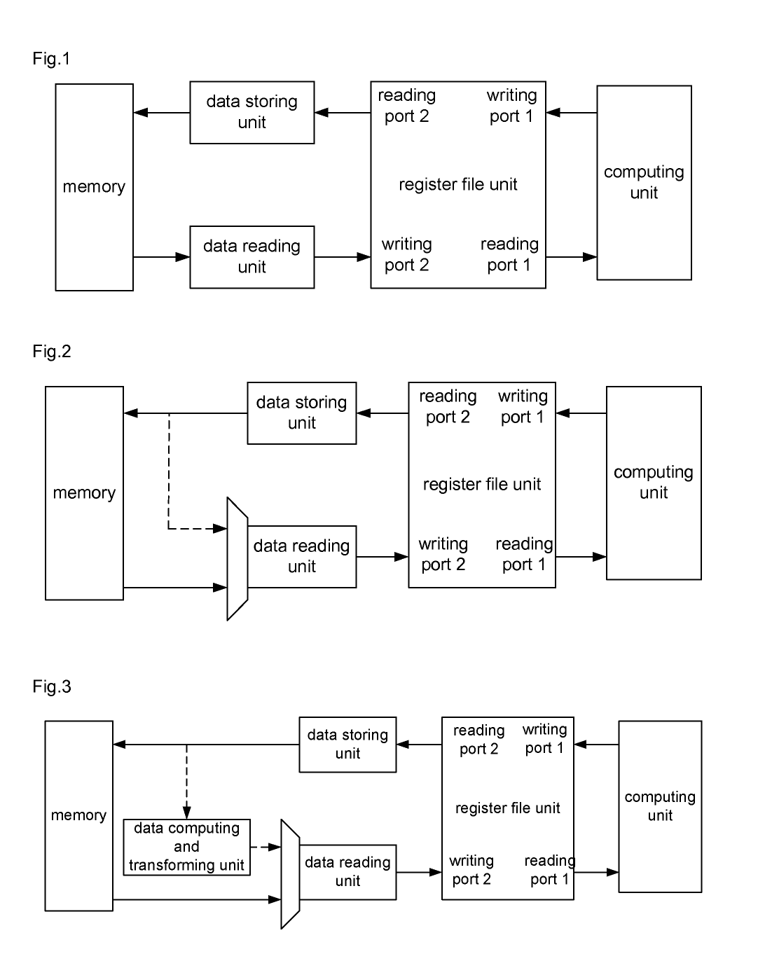

### DETAILED DESCRIPTION

A technical solution of the disclosure is further elaborated below with reference to the drawings and specific embodiments.

A loopback structure of a processor provided by the disclosure mainly includes a register file unit, a data storing unit, and a data reading unit: wherein the register file unit is configured to provide a data reading-writing service for the data storing unit and the data reading unit; the data storing unit, which is connected to the register file unit, is configured to read data via a reading port of the register file unit, to perform a data transformation on the read data, and to feed the transformed data back to the data reading unit; and the data reading unit, which is connected to the register file unit and the data storing unit, is configured to transform the data fed back by the data storing unit, and to write the transformed data in the register file unit via a writing port of the register file unit.

Preferably, a data computing and transforming unit may also be connected between the data storing unit and the data reading unit, and the data computing and transforming unit is configured to further perform computation and transformation processing on the data fed back by the data storing unit, and to provide the processed data for the data reading unit.

In addition, when processing the data read via the reading port, the data storing unit needs to mask an operation directed to a memory of the processor by the data storing unit itself.

Furthermore, the loopback structure may further include a computing unit, which is connected to the register file unit and is configured to read a source operand from the register file unit, to perform a data computation based on the source operand, and to write a result of the computation in the register file unit.

Then, the data storing unit may be further configured to read the result of the computation based on the source operand via the reading port of the register file unit, to perform the data transformation on the read result of the computation, and to feed the transformed result of the computation back to the data reading unit; and

accordingly, the data reading unit is configured to transform the result of the computation fed back by the data storing unit, and to write the transformed result of the computation in the register file unit via the writing port of the register file unit.

A data loopback processing method of a processor provided by the disclosure mainly includes:

reading, by a data storing unit, data via a reading port of a register file unit, performing, a data transformation on the read data, and feeding the transformed data back to a data reading unit; and

transforming, by the data reading unit, the data fed back by the data storing unit, and writing the transformed data in the register file unit via a writing port of the register file unit.

Preferably, the method further includes: reading, by a computing unit connected to the register file unit, a source operand from the register file unit, performing a data computation based on the source operand, and writing a result of the computation in the register file unit.

Then accordingly, the data storing unit may read the result of the computation based on the source operand via the reading port of the register file unit, perform the data transformation on the read result of the computation, and feed the transformed result of the computation back to the data reading unit; and

the data reading unit may transform the result of the computation fed back by the data storing unit, and write the transformed result of the computation in the register file unit via the writing port of the register file unit.

That is, what the data storing unit reads from the register file unit may or may not be the result of the computation by the computing unit. If in a specific implementation, the intention is to utilize only a special data transformation function of the data storing unit and the data reading unit without any operation directed to the memory, then what the data storing unit reads from the register file unit may not be the result of the computation by the computing unit.

It may be seen that the disclosure provides an instruction and a channel directly from the data storing unit to the data reading unit; by providing the instruction and channel, after the computation by the computing unit and the data transformation by the data storing unit, data are not written into the memory directly, but are looped and fed back to the data reading unit. The channel reuses the special data transformation function of the data storing unit and the data reading unit (including data rotation-displacement and the like) as well as their reading and writing ports of the register file unit; this channel and the channel of “register file unit→computing unit→register file unit” are independent of each other, and may operate in parallel, that is, they may work independently without affecting each other.

Note that in the disclosure the channel of “register file unit→data storing unit→data reading unit→register file unit” and the channel of “register file unit→computing unit→register file unit” may cooperate with each other to form a closed loop. The solution of the disclosure is described below with specific embodiments.

A loopback structure of a processor provided by an embodiment of the disclosure, as shown in FIG. 2, mainly includes a data reading unit, a register file unit, a computing unit, and a data storing unit; wherein a front channel is formed by a data channel through a first reading port of the register file unit (i.e. reading port 1 shown in the figure), the computing unit, a first writing port of the register file unit (i.e. writing port 1 shown in the figure); and a back channel is formed by a data channel through a second reading port of the register file unit (i.e. reading port 2 shown in the figure), the data storing unit, the data reading unit, a second writing port of the register file unit (i.e. writing port 2 shown in the figure). A dotted-line arrow in FIG. 2 indicates a route on which data are looped.

The computing unit is configured to read a source operand via reading port 1 of the register file unit, to perform a data computation based on the source operand, and to write a result of the computation in the register file unit via writing port 1 of the register file unit;

The data storing unit is configured to read the result of the computation via reading port 2 of the register file unit, to perform the data transformation on the result of the computation, and to feed the transformed result of the computation to the data reading unit;

The data reading unit is configured to transform the data fed back by the data storing unit, and to write the transformed data in the register file unit via writing port 2 of the register file unit; and

the register file unit is configured to provide a data reading-writing service for the computing unit, the data storing unit, and the data reading unit.

It may be seen from the loopback structure of a processor shown in FIG. 2 that in order to increase efficiency of the processor and reduce power consumption of the processor, the disclosure provides an instruction and a channel directly from the data storing unit to the data reading unit (namely, the back channel). By providing the instruction and channel, after the computation by the computing unit and the data transformation by the data storing unit, data are not written into the memory directly, but are looped and fed back to the data reading unit. The back channel reuses the special data transformation function of the data storing unit and the data reading unit (such as data rotation-displacement and the like) as well as their reading and writing ports of the register file unit. With such a data feedback strategy, reading and writing operations to the memory by the processor, or any reading and writing conflicts due to such operations to the memory, is exempted.

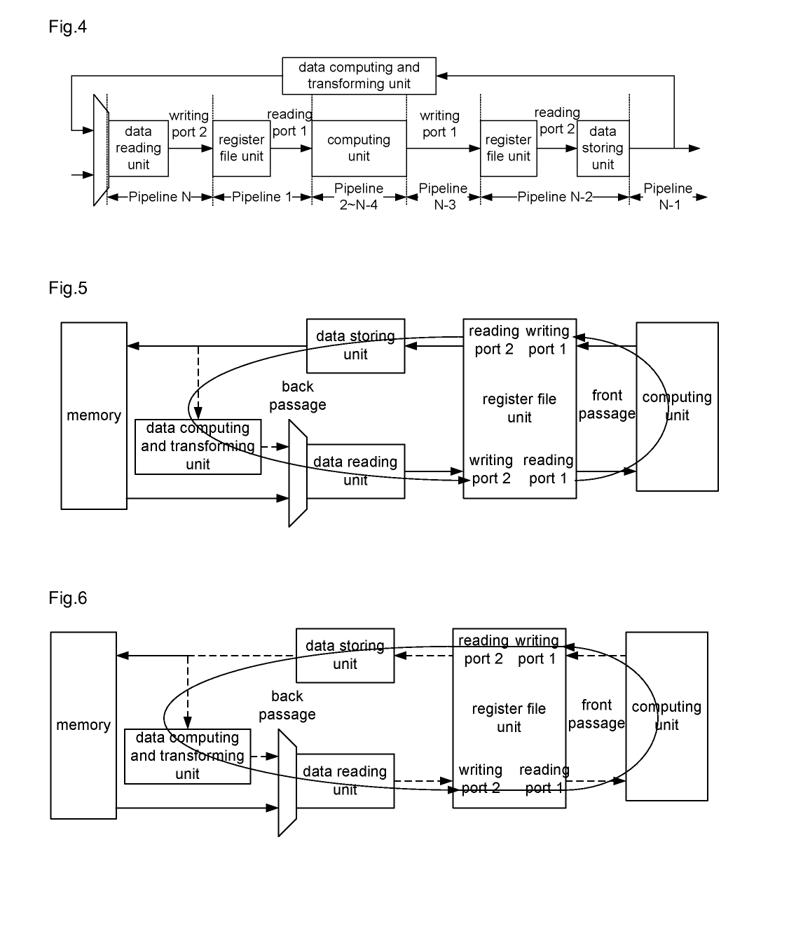

In addition, as another embodiment of the disclosure, another component (for example, a data computing and transforming unit) for performing additional data computation and data transformation may be added between the data storing unit and the data reading unit. A loopback structure of a processor of this embodiment is as shown in FIG. 3, wherein a front channel is formed by a data channel through a first reading port of the register file unit (i.e. reading port 1 in the figure), the computing unit, a first writing port of the register file unit (i.e. writing port 1 in the figure); and a back channel is formed by a data channel through a second reading port of the register file unit (i.e. reading port 2 shown in the figure), the data storing unit, the data computing and transforming unit, the data reading unit, and a second writing port of the register file unit (i.e. writing port 2 shown in the figure). The dotted-line arrow in FIG. 3 indicates a route on which data are looped. FIG. 4 indicates an instruction pipeline of a processor for data loopback processing, wherein starting from reading data by the computing unit from the register file unit and ending at writing data back to the register file unit via the data reading unit, the instruction pipeline for looping back data requires N clock periods in total, each period corresponding to a stage of the pipeline. The function of each stage will now be described as follows.

Stage 1 (also called pipeline 1): a computing unit reads a source operand via reading port 1 of a register file unit;

Stage 2˜N-4: the computing unit performs data computation based on the source operand;

Stage N-3: the computing unit writes a result of the computation in the register file unit via writing port 1 of the register file unit;

Stage N-2: a data storing unit reads the result of the computation via reading port 2 of the register file unit, performs a data transformation (for example, data rotation-displacement) on the result of the computation, and puts the transformed result of the computation on a data storing bus;

Stage N-1: a data computing and transforming unit acquires data from the data storing bus, performs further computation and transformation processing on the data, and copies the processed data onto a data reading bus; meanwhile, the data storing unit has to mask an operation directed to a memory;

Stage N: a data reading unit acquires the data from the data reading bus, performs a data transformation (for example, data rotation-displacement) on the acquired data, and writes the transformed data in the register file unit via writing port 2 of the register file unit.

Assume that N=9, thus 9 periods are required to complete one loopback instruction. In a case of no loopback instruction, to complete an operation with the same function, additional periods are required for accessing the memory. Assume that a writing operation directed to the memory requires one period, and a reading operation directed to the memory requires 3 periods, thus 13 periods are required altogether. It can thus be seen that in this case the efficiency of the processor may be increases by about 30% by using the data loopback instruction and the loopback structure. That is, the loopback structure adopted by the disclosure allows all data to circulate within a processor core, which can effectively increase performance of the processor and reduce the power consumption of the processor.

Note that, as shown in FIG. 5, the front channel (register file unit→computing unit→register file unit) and the back channel (register file unit→data storing unit→data reading unit→register file unit) are in different stages of the whole pipeline of the processor. Therefore, they operate independently in parallel, and may operate different registers or operate a same register. Namely, registers in the register file unit used by the back channel and by the front channel may be same or different. When the front channel and the back channel operate the same register (that is, the front channel and the back channel use the same one register in the register file unit), a closed loop will form between them, as shown in FIG. 6.

If the intention is to utilize only the special data transformation function of the data storing unit and the data reading unit without any operation directed to the memory, it is not required to form the closed loop as shown in FIG. 6. However, in some computations with small data size, such a closed loop formed by the front channel and the back channel will allow the data being computed to circulate completely within the processing core, and allow very few register file resources being used. Multiple independent computations may be integrated to fill the whole pipeline of the loopback structure. In this case it is possible to further increase the performance and reduce the power consumption, and a throughput rate may be increased six to seven times compared to that before the computation integration, enabling a utilization rate of near 100% of the computing unit.

What described are merely preferred embodiments of the disclosure, and are not intended to limit the scope of the disclosure.

What is claimed is:

1. A loopback structure of a processor, comprising a register file unit, a data storing unit, and a data reading unit; wherein
the register file unit is configured to provide a data reading-writing service for the data storing unit and the data reading unit;
the data storing unit, which is connected to the register file unit, is configured to read data via a reading port of the register file unit, to perform a data transformation on the read data, and to feed the transformed data back to the data reading unit; and
the data reading unit, which is connected to the register file unit and the data storing unit, is configured to transform the data fed back by the data storing unit, and to write the transformed data in the register file unit via a writing port of the register file unit.

2. The loopback structure according to claim 1, wherein a data computing and transforming unit is connected between the data storing unit and the data reading unit,
the data computing and transforming unit is configured to perform computation and transformation processing on the data fed back by the data storing unit, and to provide the processed data to the data reading unit.

3. The loopback structure according to claim 1, wherein the data storing unit is configured to mask an operation directed to a memory of the processor by the data storing unit itself when the data storing unit processes the data read via the reading port.

4. The loopback structure according to claim 1, further comprising a computing unit connected to the register file unit and configured to read a source operand from the register file unit, to perform a data computation based on the source operand, and to write a result of the computation in the register file unit.

5. The loopback structure according to claim 4, wherein the data storing unit is configured to read the result of the computation based on the source operand via the reading port of the register file unit, to perform the data transformation on the read result of the computation, and to feed the transformed result of the computation back to the data reading unit; and
the data reading unit is configured to transform the result of the computation fed back by the data storing unit, and to write the transformed result of the computation in the register file unit via the writing port of the register file unit.

6. The loopback structure according to claim 1, wherein the data transformation is a data rotation-displacement operation.

7. A data loopback processing method of a processor, comprising:
reading, by a data storing unit, data via a reading port of a register file unit, performing a data transformation on the read data, and feeding the transformed data back to a data reading unit; and
transforming, by the data reading unit, the data fed back by the data storing unit, and writing the transformed data in the register file unit via a writing port of the register file unit.

8. The method according to claim 7, further comprising:
performing, by a data computing and transforming unit connected between the data storing unit and the data reading unit, performing computation and transformation processing on the data fed back by the data storing unit, and providing the processed data to the data reading unit.

9. The method according to claim 7, further comprising:
masking, by the data storing unit, an operation directed to a memory of the processor by the data storing unit itself when the data storing unit processes the data read via the reading port.

10. The method according to claim 7, further comprising:
reading, by a computing unit connected to the register file unit, a source operand from the register file unit, performing a data computation based on the source operand, and writing a result of the computation in the register file unit.

11. The method according to claim 10, further comprising:
reading, by the data storing unit, the result of the computation based on the source operand via the reading port of the register file unit, performing the data transformation on the read result of the computation, and feeding the transformed result of the computation back to the data reading unit; and
transforming, by the data reading unit, the result of the computation fed back by the data storing unit, and writing the transformed result of the computation in the register file unit via the writing port of the register file unit.

12. The method according to claim 7, wherein the data transformation is a data rotation-displacement operation.

13. The loopback structure according to claim 2, wherein the data storing unit is configured to mask an operation directed to a memory of the processor by the data storing unit itself when the data storing unit processes the data read via the reading port.

14. The loopback structure according to claim 2 further comprising a computing unit connected to the register file unit and configured to read a source operand from the register file unit, to perform a data computation based on the source operand, and to write a result of the computation in the register file unit.

15. The loopback structure according to claim 14, wherein the data storing unit is configured to read the result of the computation based on the source operand via the reading port of the register file unit, to perform the data transformation on the read result of the computation, and to feed the transformed result of the computation back to the data reading unit; and
the data reading unit is configured to transform the result of the computation fed back by the data storing unit, and to write the transformed result of the computation in the register file unit via the writing port of the register file unit.

16. The loopback structure according to claim 2, wherein the data transformation is a data rotation-displacement operation.

17. The method according to claim 8, further comprising:
masking, by the data storing unit, an operation directed to a memory of the processor by the data storing unit itself when the data storing unit processes the data read via the reading port.

18. The method according to claim 8, further comprising:
reading, by a computing unit connected to the register file unit, a source operand from the register file unit, performing a data computation based on the source operand, and writing a result of the computation in the register file unit.

19. The method according to claim 18, further comprising:
reading, by the data storing unit, the result of the computation based on the source operand via the reading port of the register file unit, performing the data transformation on the read result of the computation, and feeding the transformed result of the computation back to the data reading unit; and
transforming, by the data reading unit, the result of the computation fed back by the data storing unit, and writing the transformed result of the computation in the register file unit via the writing port of the register file unit.

20. The method according to claim 8, wherein the data transformation is a data rotation-displacement operation.
